(19) United States
(12) Patent Application Publication
(10) Pub. No.: US 2024/0193443 A1
(43) Pub. Date: Jun. 13, 2024

(54) ANALYZING AND ALTERING AN EDGE DEVICE POLICY USING AN ARTIFICIAL INTELLIGENCE (AI) REASONING MODEL

(71) Applicant: International Business Machines Corporation, Armonk, NY (US)

(72) Inventors: Nathan Andrew Phelps, Durham, NC (US); Ryan Anderson, Kensington, CA (US); Ashok Kumar Iyengar, Encinitas, CA (US); Kavitha Bade, Durham, NC (US); Joseph Andrew Pearson, Brookhaven, GA (US); Troy Fine, Sutter Creek, CA (US)

(21) Appl. No.: 18/077,006

(22) Filed: Dec. 7, 2022

(51) Int. Cl. G06N 5/04

(52) U.S. Cl. CPC G06N 5/04

(57) ABSTRACT

A computer-implemented method, according to one embodiment, includes deploying a policy to edge devices in an edge computing environment. The method further includes analyzing, using an artificial intelligence (AI) reasoning model, the policy to understand an intent of deploying the policy. The analyzing includes discounting a weight value assigned to data points that are determined to not apply to a current decision of a first of the edge devices. The method further includes causing the policy to be altered based on the analysis. A computer program product, according to another embodiment, includes a computer readable storage medium having program instructions embodied therewith. The program instructions are readable and/or executable by a computer to cause the computer to perform the foregoing method.

### BACKGROUND

The present invention relates to edge computing, and more specifically, this invention relates to using an artificial intelligence (AI) reasoning model to analyze and alter an edge device policy.

Edge computing typically involves any sort of computing that occurs outside the confines, e.g., the physical walls, of a traditional data center. Accordingly, in some implementations, edge computing typically does not refer to relatively large computing realms, e.g., relatively large compute facilities, the cloud, public or private clouds, etc., but rather computing that occurs outside of these realms of computing environments. On an opposite side of the spectrum, edge computing typically does not refer to relatively small computing realms, e.g., such as a constrained device that cannot run an operating system such as LINUX, systems that cannot run containerized applications, fixed function general compute devices such as some programmable thermostats, etc. Instead, edge computing devices typically refer to devices that are capable of running an operating system such as LINUX and/or are capable of running containerized applications, e.g., such as an ARM-32 micro-architecture device, an ARM-64 micro-architecture device, an X86 micro-architecture device, Z micro-architecture devices, etc., other devices such as sensors with digital outputs, RISC-V architectures, etc.

In addition to edge devices, an edge computing environment may include an edge hub. In a control plane perspective of computing, an edge hub may be a software solution that outputs commands to the edge devices. The edge hub may contain a centralized storage component that includes information about each of the edge devices of the edge computing environment, and may or may not be able to directly control the edge devices.

Edge computing environments may utilize a plurality of policies, depending on the use case scenario. For example, a “node policy” may be provided by a node owner during registration of a node. A purpose of the node policy may be to define features that the node has and an intended purpose of the node. Furthermore, a “service policy” may be provided by a service provider upon publishing a service. The service policy may define what the service needs on an edge node to run properly and its intent. A “deployment policy” may be provided by a policy administrator upon a service being deployed. The deployment policy may be applied to the edge computing devices of an edge computing environment, and define where services should run. At a relatively high level, the deployment policy is a match between a service and a “destination,” which may be another term, within this context, for an edge device. The deployment policy includes predefined rules and/or constraints that each of the edge devices are subject to. Finally, a “model policy” may be provided by a model creator and/or data scientist upon creating a model. The model policy may further limit an edge node that the model is deployed to.

### SUMMARY

A computer-implemented method, according to one embodiment, includes deploying a policy to edge devices in an edge computing environment. The method further includes analyzing, using an artificial intelligence (AI) reasoning model, the policy to understand an intent of deploying the policy. The analyzing includes discounting a weight value assigned to data points that are determined to not apply to a current decision of a first of the edge devices. The method further includes causing the policy to be altered based on the analysis.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3A is a flowchart of a method, in accordance with one embodiment of the present invention.

FIG. 3B is a flowchart of sub-operations of an operation of the flowchart of FIG. 3A, in accordance with one embodiment of the present invention.

FIG. 4 is a representation of an edge computing environment, in accordance with one embodiment of the present invention.

FIG. 5 is a device table schema, in accordance with one embodiment of the present invention.

FIG. 6A is a representation of an edge computing environment, in accordance with one embodiment of the present invention.

FIG. 6B is a representation of an edge computing environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using an artificial intelligence (AI) reasoning model to analyze and alter an edge device policy.

In one general embodiment, a computer-implemented method includes deploying a policy to edge devices in an edge computing environment. The method further includes analyzing, using an artificial intelligence (AI) reasoning model, the policy to understand an intent of deploying the policy. The analyzing includes discounting a weight value assigned to data points that are determined to not apply to a current decision of a first of the edge devices. The method further includes causing the policy to be altered based on the analysis.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as edge device policy analysis module of block 200 for deploying, analyzing, and altering a policy in an edge computing environment. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

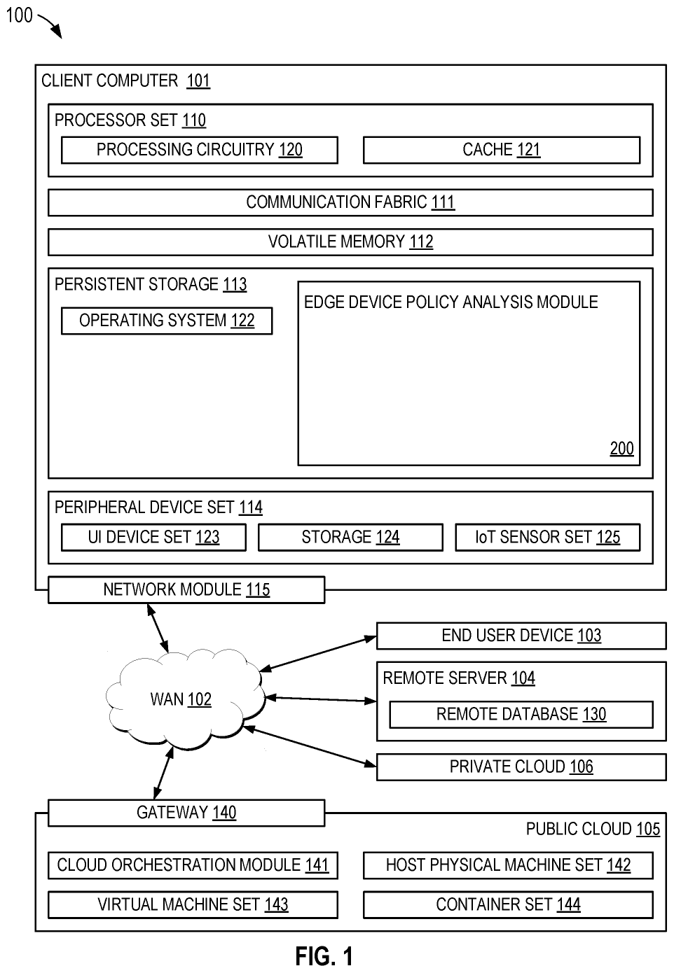

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

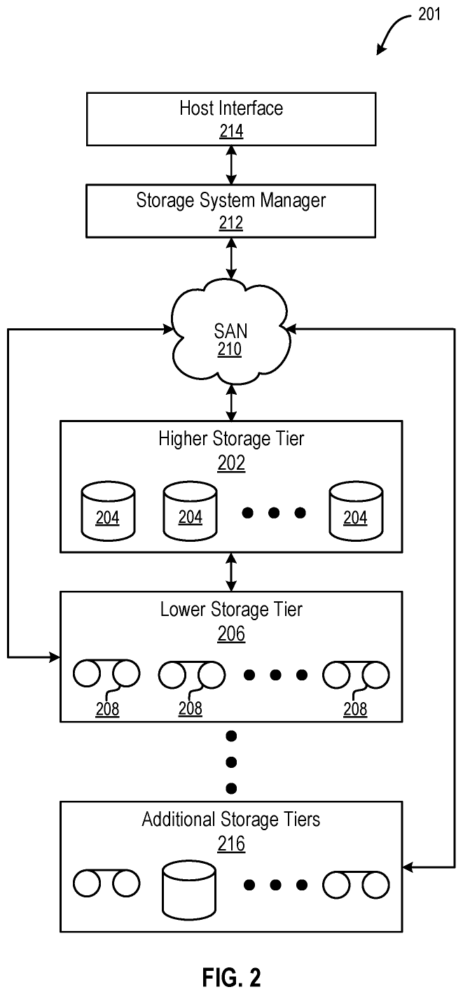

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

As mentioned elsewhere above, edge computing typically involves any sort of computing that occurs outside the confines, e.g., the physical walls, of a traditional data center. Accordingly, in some implementations, edge computing typically does not refer to relatively large computing realms, e.g., relatively large compute facilities, the cloud, public or private clouds, etc., but rather computing that occurs outside of these realms of computing environments. On an opposite side of the spectrum, edge computing typically does not refer to relatively small computing realms, e.g., such as a constrained device that cannot run an operating system such as LINUX, systems that cannot run containerized applications, fixed function general compute devices such as some programmable thermostats, etc. Instead, edge computing devices typically refer to devices that are capable of running an operating system such as LINUX and/or are capable of running containerized applications, e.g., such as an ARM-32 micro-architecture device, an ARM-64 micro-architecture device, an X86 micro-architecture device, Z micro-architecture devices, etc., other devices such as sensors with digital outputs, RISC-V architectures, etc.

In addition to edge devices, an edge computing environment may include an edge hub. In a control plane perspective of computing, an edge hub may be a software solution that outputs commands to the edge devices. The edge hub may contain a centralized storage component that includes information about each of the edge devices of the edge computing environment, and may or may not be able to directly control the edge devices.

Edge computing environments may utilize a plurality of policies, depending on the use case scenario. For example, a “node policy” may be provided by a node owner during registration of a node. A purpose of the node policy may be to define features that the node has and an intended purpose of the node. Furthermore, a “service policy” may be provided by a service provider upon publishing a service. The service policy may define what the service needs on an edge node to run properly and its intent. A “deployment policy” may be provided by a policy administrator upon a service being deployed. The deployment policy may be applied to the edge computing devices of an edge computing environment, and defines where services should run. At a relatively high level, the deployment policy is a match between a service and a “destination,” which may be another term within this context for an edge device. The deployment policy includes predefined rules and/or constraints that each of the edge devices are subject to. Finally, a “model policy” may be provided by a model creator and/or data scientist upon creating a model. The model policy may further limit an edge node that the model is deployed to.

Rules and constraints of a policy are often statically applied to conventional edge computing environments. More specifically, once applied within conventional edge computing environments, rules and constraints of a policy are not dynamically adjusted based on an overall performance of the conventional edge computing environment. Instead, human administrators are often responsible for evaluating the performance of edge devices with respect to rules and constraints in a conventional edge computing environment. Deciding whether or not to deploy a single application to a device, e.g., such as an edge device, may be a relatively simple decision for such a human administrator. Furthermore, determining whether an application can and should be deployed to a fleet of three or fewer devices is potentially able to be performed by a human administrator. For example, management of this relatively small fleet of devices may include determining whether each of the devices meet applied rules and/or constraints, and in response to a determination that the devices meet applied rules and/or constraints, applying a predetermined application on such devices. However, such evaluations and considerations are static and not able to be dynamically performed by a human administrator in a scaled edge computing environment. For example, for a fleet of one-hundred or more edge devices, it is readily apparent that human administrators are not capable of evaluating application deployments. Accordingly, there exists a longstanding need for automatically and ongoingly determining whether a deployment policy in an edge computing environment should be altered.

In sharp contrast to the deficiencies described above, the techniques of various embodiments and approaches described herein include using an artificial intelligence (AI) reasoning model to monitor and alter a deployment policy in an edge computing environment. This AI reasoning model is in some preferred approaches based on a neuro symbolic AI model. More specifically, such techniques include deploying an original deployment policy, and observing and assessing, by an AI reasoning model, the original deployment policy. This observing and assessing includes downgrading data points that do not apply to a current decision and understanding an intent of the original deployment policy. Furthermore, altering, e.g., with one or more policy supplements, is performed on the original deployment policy, based on the observing and assessing. This enables the policy to be dynamically adjusted based on conditions within the edge computing environment. As a result, performance of edge devices in the edge computing environment improves based on these adjustments. A primary benefit of incorporating these techniques into edge computing environments includes an enablement of decision making based on what would otherwise be an “intent” of a human administrator if the human were otherwise able to dynamically manage the edge computing environments (which humans are not capable of managing in a scaled out environment). More specifically, these benefits are enabled where such intent may not be reflected in data associated with the edge computing environment. This in turn improves relatively effective scaling of deployments to relatively large device fleets, e.g., such as over one million devices, in a timely fashion. This furthermore allows such decisions to be constantly re-evaluated for continued effectiveness at a rapid cadence based on conditions in effect at a given moment and conditions that are unique to each individual edge device. These techniques, furthermore, allow deployment decisions that understand an implicit and explicit context in a manner that a human otherwise might have with respect to a single device deployment. This understanding may be attained by determining a semantic meaning of data and how that understanding applies to both key performance indicators (KPIs) and an administrator's expressed intent. Based on these factors, the policies deployed to edge devices are dynamically altered to reflect dynamically changing conditions that the edge devices experience in an edge computing environment.

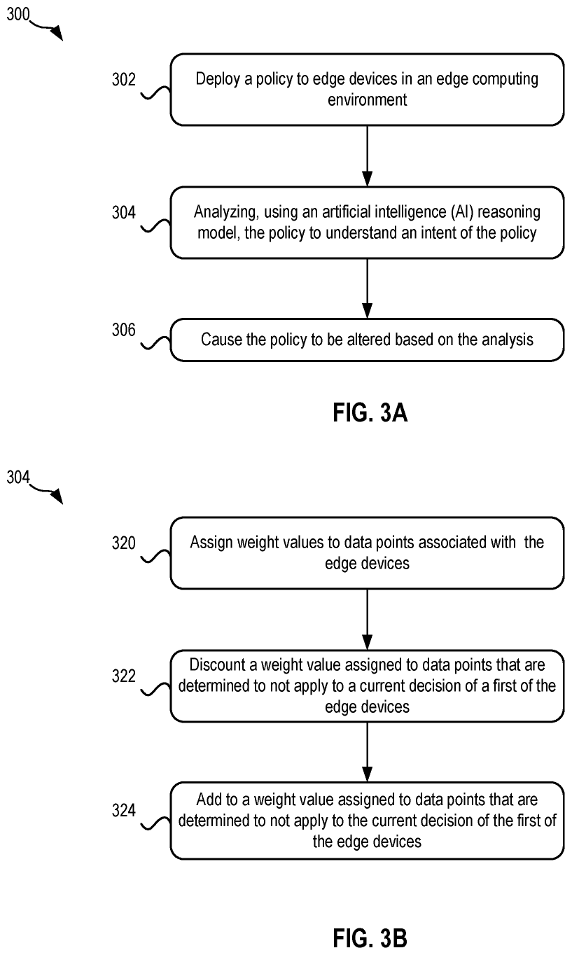

Now referring to FIG. 3, a flowchart of a method 300 for edge computing workload deployments utilizing an AI reasoning model is shown, according to one embodiment. The method 300 may be performed in accordance with the present invention in any of the environments depicted in FIGS. 1-6B, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Operation 302 includes deploying a policy, e.g., an original deployment policy, to edge devices in an edge computing environment. For context, the edge computing environment may include a plurality of edge devices. The edge computing environment may additionally and/or alternatively include an edge hub. The edge hub is, in some approaches, not able to directly query the edge devices, but may receive information from one or more of the edge devices. Such information may include performance metrics of the edge device that sends the metrics. For example, a non-limiting list of such performance metrics may include, e.g., memory resources of the edge device, a type of memory that the edge device uses, an amount of processing operations being performed and/or capable of being concurrently performed by the edge device, CPU resources of the edge device, a geographical location of the edge device, whether the edge device is in motion, an ID of the edge device, information about an owner of the edge device, a model number of the edge device, a software and/or program version that is being run on the edge device, etc. In some other approaches, the performance metrics may additionally and/or alternatively include information about components that the edge devices includes and/or has access to controlling, e.g., such as a camera, a port, a microphone, etc. Performance metrics received from edge devices may be stored as information in a predetermined device table, e.g., by the edge hub.

It should be noted that although various approaches described herein are described with respect to deploying a single policy to the edge devices, in some other approaches, a plurality of policies may additionally and/or alternatively be deployed to at least some of the edge devices.

In some approaches, a policy that is deployed to one or more edge devices in the edge computing environment may specify rules and/or constraints that an edge device is to have. In response to a determination that an edge device satisfies such rules and/or constraints of the deployed policy, a predetermined application that is associated with the deployed policy may be caused to be run on the edge device. This selective implementation of applications based on the policy may control what workloads are run on the edge devices.

The policy may specify one or more types of rules and/or constraints that would become appreciated by one of ordinary skill in the art upon reading descriptions herein. For example, in some approaches, a policy that is deployed to one or more edge devices in the edge computing environment may specify that an edge device is to have a predetermined amount of CPU. In one approach, the predetermined amount of CPU may be an amount of CPU resources that are not currently being used, and therefore are available. In another approach, the predetermined amount of CPU may be a total amount of CPU resources that a given edge device is outfitted with. In response to a determination that an edge device has CPU resources that satisfy rules and/or constraints of the deployed policy, a predetermined application that is associated with the deployed policy may be caused to be run on the edge device. In one example, such an application may be one that assigns operations to be fulfilled by the CPU of the edge device. In another approach, the application may be one that uses the CPU resources of the edge device to run on the edge device, e.g., and therefore the policy acts ensures that there is an amount of CPU resources available needed to run the associated application.

In some other approaches, a policy that is deployed to one or more edge devices in the edge computing environment may specify that an edge device is to have a predetermined amount of storage. In one approach, the predetermined amount of storage may be storage resources that are not currently being used, e.g., are available for reclaiming, do not include any data written thereto, etc., and therefore are available. In another approach, the predetermined amount of storage may be a total amount of storage space that a given edge device is outfitted with. In response to a determination that an edge device has storage resource that satisfy rules and/or constraints of the deployed policy, a predetermined application that is associated with the deployed policy may be caused to be run on the edge device. In one example, such an application may be one that assigns data write operations to a predetermined storage component of the edge device. In another approach, the application may be one that manages the storage resources of the edge device, e.g., manages data stored on the storage resources of the edge device.

Rules and or constraints of a policy may be based on properties and/or characteristics of an edge device itself in some approaches. For example, in some approaches a policy that is deployed to one or more edge devices in the edge computing environment may specify rules and/or constraints that are related to a geographical location of an edge device which may change over time. For example, a policy that is deployed to one or more edge devices in the edge computing environment may specify that an edge device is to, e.g., be located within a predetermined bounded geographical location, within a predetermined distance from a predetermined landmark, within a predetermined time zone, etc. In another example, a policy that is deployed to one or more edge devices in the edge computing environment may specify whether an edge device is to be moving or not, e.g., moving at at least a predetermined rate, non-stationary, moving at least a predetermined distance within each predetermined amount of time, etc. In response to a determination that an edge device satisfies such rules and/or constraints of the deployed policy, a predetermined application that is associated with the deployed policy may be caused to be run on the edge device.

In some other approaches, rules and or constraints of the policy may additionally and/or alternatively be based on one or more operator specified purposes. For example, a predetermined specified purpose may include loss prevention. In such an approach, the rules and/or contrasting may be based on predetermined targeting strategies that may be used which may be based on static and dynamic properties. In some other approaches, the rules and or constraints of the policy may additionally and/or alternatively be based on a type of storage that the edge device uses, a relative size of nodes of the edge device, etc.

Subsequent to deploying the policy to the edge devices, information associated with the edge devices may be received, e.g., from the edge devices. In some approaches, the information is received by an edge hub and stored in a predetermined device table. This information may, in some approaches, include performance metrics of the edge devices, where such performance metrics are based on the policy being deployed to the edge devices and/or applications associated with the deployed policy being run on one or more edge devices that satisfy rules and/or constraints of the policy. For example, this information may be based on data points that include, e.g., runtime information, edge device processor utilization, edge device storage capacity, edge device movement information, edge device location information, etc.

The information associated with the edge devices may be analyzed to determine an intent of the policy deployed to the edge devices and/or whether to alter the policy to improve performance of the edge devices in the edge computing environment. For example, operation 304 includes analyzing, using an artificial intelligence (AI) reasoning model, the policy to understand an intent of the policy. For context, an “intent” of the party may be defined as a purpose and/or goal of deploying the policy. More specifically, in some approaches, this goal may be defined as an intent that an administrator would potentially identify on a much smaller scale of the edge computing environment. It should be noted however that, as described elsewhere herein, a scale of the edge computing environment is not one that an administrator is able to manage deployments within. As will now be described below, in some preferred approaches, this intent is determined and achieved by deploying an original policy, e.g., see operation 302, and thereafter analyzing and altering the policy to include properties and constraints, e.g., boundaries, that relatively improve performance of the edge computing environment. More specifically, in one or more of such approaches, the amended policy contains properties which declare what the intent is, and rules and/or constraints which declare boundaries of the intent.

It should also be noted that although various approaches are described herein with respect to use of a single AI reasoning model, in some other approaches, various operations described herein may be based on and/or performed by more one AI reasoning model, e.g., a plurality of AI reasoning models. Furthermore, in some approaches, the AI reasoning model(s) may use one or more modules to perform one or more of the operations described herein. For example, the edge device policy analysis module of block 200 of FIG. 1 may be used for deploying, analyzing, and altering a policy in an edge computing environment, in some approaches. In some other approaches, the term “model” may fundamentally be an artifact that has been trained to perform in a certain way and one of the fundamental attributes of it is that there is a training element that requires the consumption of data and then the creation of a model artifact that is deployed to the edge to perform some piece of work in a deterministic manner. “Model” as a relatively narrow logical construct may consume inputs of data and provide outputs, based on training on prior knowledge. In contrast, a “module” may, in some approaches, be a word used to describe a composition of technologies (which may or may not include a model) which may include a hardware operating system, software networking sensors, etc. In some approaches, the term module may be used interchangeably with the term “edge device.”

The analyzing may, in some approaches, include performing predetermined observing and/or assessing operations defined within the AI reasoning model. In some preferred approaches, the AI reasoning model is a neuro-symbolic AI model. Approaches in which the AI reasoning model is a neuromyotonic AI model may improve performance of computer devices in the edge computing environment because the neuromyotonic AI model may not need a subject matter expert and/or iteratively applied training with reward feedback in order to accurately analyze the deployed policy. Instead, the neuromyotonic AI model is configured to itself make accuracy assessments and alter a policy based on such assessments. Various techniques for using the AI reasoning model to analyze the deployed policy are described below.

Weight values may, in some approaches, be used by the AI reasoning model to analyze the deployed policy. Looking to FIG. 3B, exemplary sub-operations of analyzing, using the AI reasoning model, the original deployment policy to understand an intent of the policy, are illustrated in accordance with one embodiment, one or more of which may be used to perform operation 304 of FIG. 3A. However, it should be noted that the sub-operations of FIG. 3B are illustrated in accordance with one embodiment which is in no way intended to limit the invention.

With continued reference to FIG. 3B, sub-operation 320 includes assigning weight values to data points associated with the edge devices. For context, the data points may characterize performance of the edge devices in some approaches. Accordingly, in some such approaches, the data points include the information associated with the edge devices received subsequent to deploying the policy. In some approaches, nominal weight values may be initially assigned to the data points. For example, a predetermined value, e.g., one, ten, one hundred, a predetermined percentage on a predetermined range such as 0%-100%, etc., may be initially assigned to all data points of the edge devices. This assignment initially equalizes all of the data points, which may thereafter be adjusted according to predetermined weight value adjustments based on the analysis of the data points.

For each sample of data points, it may be determined whether the data points apply to a current decision of at least a first of the edge devices. For context, data points that apply to a current decision of at least the first of the edge devices may be data received from edge devices that satisfy the rules and/or constraints of the policy. For example, the policy may specify that only edge devices that have been and/or currently are in motion are to be considered, e.g., such as edge devices that are attached to a drone. Edge devices that have been stationary for at least a predetermined amount of time and/or are currently stationary do not satisfy rules and/or constraints of the policy, and therefore data points of information received from such edge devices may be considered irrelevant to the current analysis of the policy. Note that data points that are considered irrelevant to the analysis may thereafter be considered relevant, e.g., such as in response to an altered version of the deployed policy considering stationary edge devices, in response to the edge device beginning to move, etc. In another example, it may be assumed that the deployed policy includes a rule and/or constraint that specifies that edge devices are to include at least a predetermined amount of available CPU resources. Edge devices that do not include the predetermined amount of available CPU resources do not satisfy rules and/or constraints of the policy, and therefore data points of information received from such edge devices may be considered irrelevant to the current analysis of the policy.

In some approaches, the AI reasoning model may analyze the policy to determine rules and/or constraints of the policy. These rules and/or constraints of the policy may call for the edge devices to include prerequisite components and/or performance metrics. Accordingly, the determination of whether an edge device, e.g., a first edge device, includes these prerequisites may define the current decision of the first device. In response to a determination that data points of information that is associated with the first edge device satisfy these rules and/or constraints, it may be determined that the data points apply to the current decision of the first edge device. In contrast, in response to a determination that data points of information that is associated with the first edge device do not satisfy these rules and/or constraints, it may be determined that the data points do not apply to the current decision of the first edge device. In some other approaches, the AI reasoning model may additionally and/or alternatively analyze the data points to determine types of operations being most commonly performed, e.g., a predetermined percentage of most commonly performed operations, by the edge devices within the edge computing environment. One or more of these types of operations may define the current decision of the at least first of the edge devices. Data points associated with these most commonly performed operations may be determined to be applicable to the current decision. In yet some other approaches, the AI reasoning model may analyze performance of the edge devices, e.g., based on the deployed policy and/or information associated with the edge devices, to determine resources that are in demand. For context, resources that are “in demand” may be resources that are not currently available in edge devices that satisfy rules and/or constraints of a current deployment of the policy. More specifically, a predetermined amount of these resources may be in demand. Accordingly, the current decision of at least the first edge device may be whether the edge device includes the resources that are in demand. Information associated with the edge devices may be analyzed by the AI reasoning model, e.g., used as an input to the AI reasoning model, to determine whether the information includes data points that apply to the current decision.

Sub-operation 322 includes discounting a weight value assigned to data points that are determined to not apply to a current decision of a first of the edge devices. For example, in response to a determination that data points do not apply to a current decision of a first of the edge devices, a weight value assigned to the data points may be discounted, e.g., a predetermined weight value, a predetermined percent, a predetermined portion of an existing weight value, to a null value to ignore the data points, etc. For context, as a result of discounting a weight value assigned to data points that are determined to not apply to a current decision of at least a first of the edge devices, these data points are considered relatively less in approaches in which relative weight values are considered for altering the policy. This enables policy alterations to focus on data that is determined by the AI reasoning model to be most beneficial for improving performance of edge devices in the edge computing environment.

Sub-operation 324 includes adding to a weight value assigned to data points that are determined to apply to the current decision of at least the first of the edge devices. For example, in response to a determination that data points apply to the current decision of the first of the edge devices, a weight value assigned to the data points may be added to, e.g., a predetermined weight value, a predetermined percent, a predetermined portion of an existing weight value, to a maximum value to highlight an importance of the data points, etc. For context, as a result of adding to a weight value assigned to data points that are determined to apply to the current decision of at least the first of the edge devices, these data points are considered relatively more in approaches in which relative weight values are considered for altering the policy, e.g., see operation 306. This enables policy alterations to focus on data that is determined by the AI reasoning model to be most beneficial for improving performance of edge devices in the edge computing environment.

With reference again to FIG. 3A, in some approaches, the analysis of operation 304 may additionally and/or alternatively be based on a first rule and/or constraint of the policy. For example, the first rule and/or constraint may specify that the first edge device is to have a key performance indicator (KPI) that exceeds a predetermined threshold, e.g., exceeds at the time of the analysis, exceeds over a predetermined portion of the deployment of the policy, etc. The KPI of the first edge device may be one that would become appreciated by one of ordinary skill in the art upon reading descriptions herein. For example, a non-limiting list of potential KPIs may include, e.g., available memory resources such as RAM, CPU resources, etc. In some other approaches, the KPI may include an edge device having access to a predetermined physical component, e.g., such as a camera, a port, a microphone, a memory component, etc. In yet some other approaches, the KPI may include an amount of processing being performed by at least some of the edge devices. In another approach, the KPI may include the edge device having at least a predetermined degree of physical movement, e.g., such as whether the first edge device is currently physically moving from a first geographical location. In some approaches, in response to a determination that an edge device has a KPI that exceeds the predetermined threshold, a weight value, e.g., a current weight value, an initial weight value, etc., assigned to the edge device may be increased. In contrast, in response to a determination that an edge device does not have a KPI that exceeds the predetermined threshold, a weight value, e.g., a current weight value, an initial weight value, etc., assigned to the edge device may be discounted. It should also be noted that in some approaches, data points associated with the first edge device may be determined to not apply to a current decision of at least a first of the edge devices in response to a determination that the KPI that is based on such data points not exceeding the predetermined threshold. As a result of adding to weight values assigned to edge devices determined to have a KPI that exceeds the predetermined threshold, these edge devices are considered relatively more in approaches in which relative weight values are considered for altering the policy, e.g., see operation 306.

In some approaches, information associated with the edge devices may be used as an input for the AI reasoning model, and an output of the AI reasoning model may include relative weight assignments for data points and/or edge devices.

Operation 306 of method 300 includes causing the original deployment policy to be altered based on the analysis. At a relatively high level, resources of edge devices having at least a predetermined weight value and/or resources of edge devices associated with such data point having at least a predetermined weight value may be caused to use a predetermined application in order to improve a relative performance of edge devices in the edge computing environment. This performance improvement may result from causing, e.g., instructing, the policy to be altered to apply to the edge devices. Various techniques for causing the policy to be altered are described below in accordance with various approaches.

In some approaches, causing the original deployment policy to be altered based on the analysis may include modifying a rule and/or constraints of the original deployment policy. In some approaches, this modification may include decreasing a relative strictness of predetermined thresholds of rules and/or policies that are used to restrict which edge devices are allowed to operate in the edge computing environment, e.g., which edge devices are allowed to apply a predetermined application. In another approach, this modification may include granting permission for edge devices associated with relatively higher weight values to be allowed to apply a predetermined application.

Causing the original deployment policy to be altered based on the analysis may additionally and/or alternatively include determining a supplement to a rule and/or constraints of the original deployment policy, and outputting an indication of the determined supplement. The supplement to a rule and/or constraints may, in some approaches, include adding and/or removing a predetermined number of the rules and/or constraints of the original deployment policy. The indication of the determined supplement may be output to, e.g., a predetermined administrator device, a predetermined storage device, a predetermined display of a device, etc. The indication may include predetermined characteristics and/or a name of the supplement in order to maintain relatively low overhead in output operations.

Numerous benefits are enabled as a result of implementing the techniques described in various approaches herein. For example, in sharp contrast to conventional techniques for managing edge computing environments, which experience a break down in throughput as an extent of the edge computing environments increases, the novel techniques herein are able to perform accurate decisions, relatively more quickly, in the absence of perfect data by deployment systems. More specifically, a primary advantage of the techniques described herein includes the enablement of machines to make human like decisions based on an intent which might not be reflected in the data. It should be noted however, that a human is not otherwise capable of performing these decisions in an edge computing environment with a plurality of edge devices. This in turn improves effective scaling of deployments to edge device fleets, e.g., to an extent that potentially extends beyond millions or billions of edge devices. This scaling is achieved in a timely manner and allows these decisions to be constantly re-evaluated for continued effectiveness at a rapid cadence based on conditions that are in effect at that moment and that are unique to each individual edge device. It should also be noted that conventional techniques fail to use or even consider the analysis techniques described herein, and particularly those that use neuro-symbolic AI. Accordingly, the inventive discoveries disclosed herein proceed contrary to conventional wisdom.

It should also be noted that conventional neural networks are not the same as the AI reasoning model described herein, and particularly the neuro-symbolic AI model described herein. This is because the techniques of conventional neural networks relatively quickly break down in a variety of situations. For example, some of these situations are when decisions need to be made before data can be collected and models trained, and/or when device fleet composition changes occur relatively more quickly than the models can be re-trained and re-deployed, e.g., new devices deployed, devices out of service, some devices patched giving different capabilities, etc. Additional of these situations where capabilities of conventional techniques relatively quickly break down include situations in which KPIs change relatively frequently and/or relatively more granularity occurs, e.g., in response to data protection regulations, privacy laws, new tenants, fleet acquisition, etc. In another of such situations, a model may be able to report on what has worked in the past, but not in the present where the environment is located in a different country. Models of these conventional techniques are furthermore not capable of understanding an administrator's intent, and data/models of these techniques are only based on correlation rather than causation. These data/models also do not express the meaning of the data points, e.g., field A corresponds to day(s) of the week. These conventional techniques also cannot directly define preexisting rules of the world and furthermore, rules of the model are not understandable to a human. Deduction is also an area where these conventional techniques have shortcomings. For at least these reasons, the techniques of embodiments and approaches described herein fulfill a longstanding need to be able to make relatively more applicable decisions, relatively more quickly, in the absence of perfect data, e.g., a type of task that a human's intent would determine but that humans have not been able to accomplish based on environment scaling. More specifically, these techniques of embodiments and approaches described herein add and/or alter policies that contain properties that declare what is, and constraints that define boundaries, to embody an administrator's intent. In some specific approaches, this enables a determination of whether existing KPIs are, or are not relevant, e.g., available RAM is below 80% utilization assumes total RAM does not exceed 32 GB. An understanding is also achieved that allows a weight value associated with data points that do not apply to a current decision to be discounted, e.g., strategies that best meet KPIs on Wednesday do not apply to Tuesday, do not update a device if it is currently being used for a critical operation, etc. An outcome that an administrator of an edge computing environment is attempting to achieve is also determined, which means understanding the intent. Factors that are not reflected in the collected data but would be obvious in other analysis are also determined. Abduction reasoning may additionally and/or alternatively be performed by the AI reasoning model to build theories about the intent and thereby determine how to alter the policy.

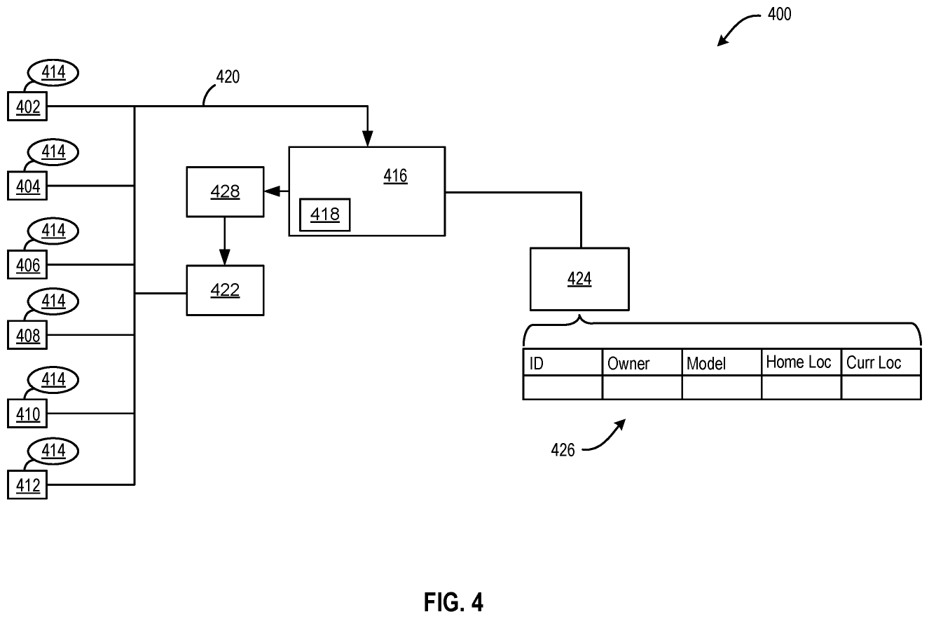

FIG. 4 depicts an edge computing environment 400, in accordance with one embodiment. As an option, the present edge computing environment 400 may be implemented in conjunction with features from any other embodiment listed herein, such as those described with reference to the other FIGS. Of course, however, such edge computing environment 400 and others presented herein may be used in various applications and/or in permutations which may or may not be specifically described in the illustrative embodiments listed herein. Further, the edge computing environment 400 presented herein may be used in any desired environment.

The edge computing environment 400 includes a plurality of edge devices, e.g., see edge device 402, edge device 404, edge device 406, edge device 408, edge device 410 and edge device 412, each having an associated agent 414. The agent may be configured to output information, e.g., performance metrics, to an edge hub 416 that includes an edge bot 418, e.g., see output operation 420. This information may be generated based on a policy 422 being deployed in the edge computing environment 400. The information may be stored in a device table 424, which has contents 426 that include, e.g., an ID of an edge device associated with the information, an owner of an edge device associated with the information, a model of an edge device associated with the information, a home loc of an edge device associated with the information, a current loc of an edge device associated with the information, etc. An original deployment policy may be deployed to the edge devices in the edge computing environment 400. Thereafter, the original deployment policy may be analyzed, using an AI reasoning model 428, e.g., a neuro-symbolic AI model, to understand an intent of the original deployment policy. The original deployment policy may be caused to be altered based on the analysis.

In some approaches, in about real time, the AI reasoning model may be configured to flags devices in use/motion. For example, performance information associated with a first of the edge device may be input into the AI reasoning mode to determine whether the first edge device is currently in motion and/or currently performing one or more predetermined operations. The AI reasoning model is able to determine a deployable sample. Such a sample is dynamic in that an edge device may be applicable to a policy in a first period of time but thereafter not be applicable to the policy in a second period of time. Accordingly, the deployable sample may include edge devices that are applicable to the policy at a time that the analysis is being performed. The AI reasoning model may also be used to generate a smart blast radius from such analysis. For example, assuming a perspective of a relatively high level set of data that defines a predetermined number of nodes, e.g., one-thousand nodes, is considered. It may also be assumed that some of the attributes of some of the nodes are obvious, e.g., small node, medium node, large node, a certain geographical location, workloads, tags that are on the nodes, etc. In some approaches, the AI reasoning model may analyze these elements, and this analysis may include performing predetermined types of grouping, e.g., nearest neighbor. Such grouping with neighboring nodes may not be a feature explicitly defined within data associated with edge devices, but the grouping may be defined using the AI reasoning model. Characteristics of this grouping may be incorporated into the policy alterations. For example, assuming that it is determined that a current policy does not enable a sufficient amount of RAM, the policy may be altered to apply to edge devices determined to be in the same group as an edge device that is determined to have available RAM resources. Accordingly, policies may be created and/or altered to be based on prevailing conditions.

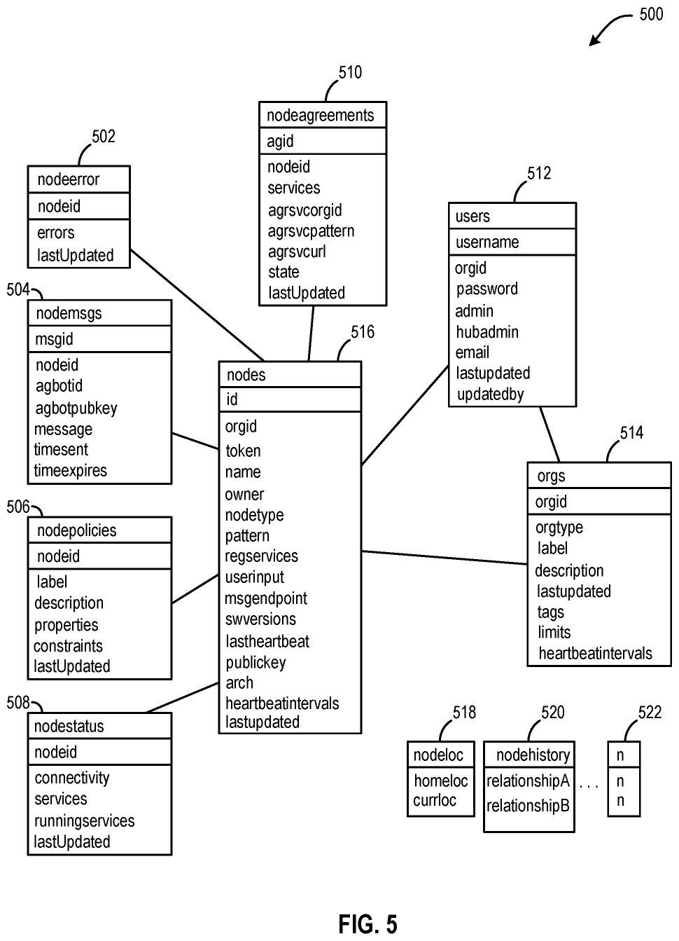

FIG. 5 depicts a device table schema 500, in accordance with one embodiment. As an option, the present device table schema 500 may be implemented in conjunction with features from any other embodiment listed herein, such as those described with reference to the other FIGS. Of course, however, such device table schema 500 and others presented herein may be used in various applications and/or in permutations which may or may not be specifically described in the illustrative embodiments listed herein. Further, the device table schema 500 presented herein may be used in any desired environment.

The device table schema 500 includes numerous collections of information associated with attributes of at least one edge device of an edge computing network. For example, a first collection 502 includes information about node errors, a second collection 504 includes information about node messages, a third collection 506 includes information about node policies, a fourth collection 508 contains information about node statuses, a fifth collection 510 includes information about node agreements, a sixth collection 512 includes information about users, and a seventh collection 514 includes information about organizations. This information may be related to a centralized node information directory 516. The device table schema 500 further includes dynamic attributes that may change over time in an edge computing environment. For example, node locations 518, node history 520, nth attributes 522, may all change over time and in response to policy alterations being made.

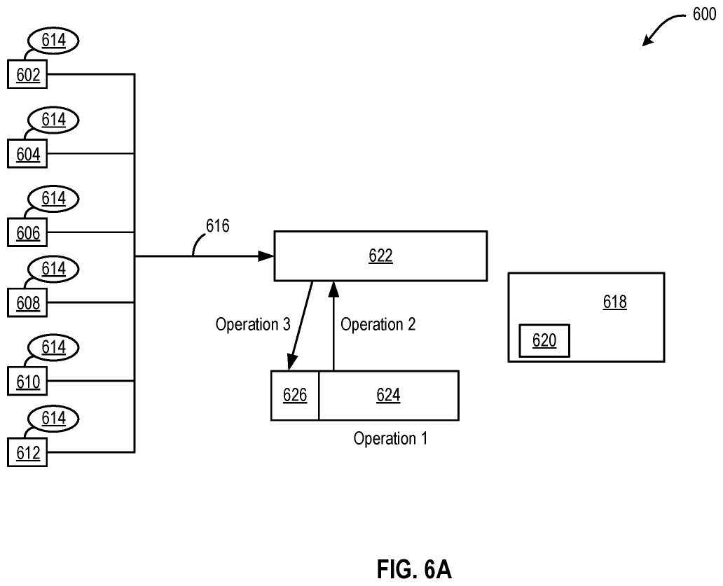

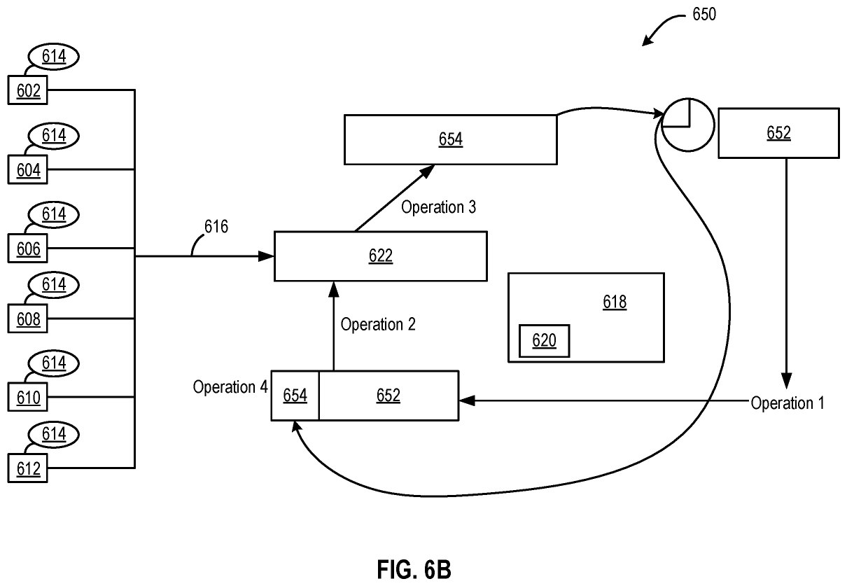

FIGS. 6A-6B depict edge computing environments 600, 650, in accordance with various embodiments. As an option, the present edge computing environments 600, 650 may be implemented in conjunction with features from any other embodiment listed herein, such as those described with reference to the other FIGS. Of course, however, such edge computing environments 600, 650 and others presented herein may be used in various applications and/or in permutations which may or may not be specifically described in the illustrative embodiments listed herein. Further, the edge computing environments 600, 650 presented herein may be used in any desired environment.

It may be prefaced that FIGS. 6A-6B depict policy alterations being caused subsequent to the policy being analyzed by an AI reasoning model. For example, referring first to FIG. 6A, a dynamic non-deterministic method for edge application orchestration using AI reasoning models to adjust or augment deployments is illustrated, according to one embodiment. An original deployment policy 624 may be deployed, e.g., see operation 1, in the edge computing environment 600 that includes a plurality of edge devices 602-612 each having an agent 614. Information based on deployment of the original deployment policy 624 is received from at least some of the edge devices, e.g., see operation 616. The information may be received by an edge hub 618 that includes a bot 620. The information may be input into an AI reasoning model 622 that is configured to analyze the original deployment policy 624 to understand an intent of the original deployment policy 624. For example, Operation 2 includes performing predetermined observation and assessment operations of the AI reasoning model. Based on the observations and analysis of the AI reasoning model, the AI reasoning model may be caused to alter the policy to improve performance of the edge computing system. More specifically, Operation 3 includes tuning the policy with supplements 626, that are thereafter deployed in the edge computing environment.

Referring now to FIG. 6B, a dynamic non-deterministic method for edge application orchestration using AI reasoning models to adjust or augment deployments is illustrated, according to one embodiment. It should be prefaced that the edge computing environment 650 includes several similar components to the edge computing environment 600, and therefore some numberings may be the same. However, note that the operations of the edge computing environment 650 may be different than the operations of the edge computing environment 600, as will be described below.

Operation 1 includes deploying an original deployment policy 652. Operations are thereafter performed by at least some of the edge devices in response to the deployment. Information received from the edge devices may be input into an AI reasoning model 622 that is configured to analyze the original deployment policy 652 to understand an intent of the original deployment policy 652. For example, Operation 2 includes performing predetermined observation and assessment operations of the AI reasoning model. Operation 3 includes the AI reasoning model observing and suggesting policy supplements 654 based on the analysis performed. Operation 4 includes adjusting and/or supplementing the original deployment policy 652. The updated policy may be deployed in the edge computing environment 650 thereafter.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
deploying a policy to edge devices in an edge computing environment;
analyzing, using an artificial intelligence (AI) reasoning model, the policy to understand an intent of deploying the policy, wherein the analyzing includes discounting a weight value assigned to data points that are determined to not apply to a current decision of a first of the edge devices; and
causing the policy to be altered based on the analysis.

2. The computer-implemented method of claim 1, comprising: assigning weight values to data points associated with the edge devices.

3. The computer-implemented method of claim 2, comprising: adding to a weight value assigned to data points that are determined to apply to the current decision of the first of the edge devices.

4. The computer-implemented method of claim 1, wherein the analysis is based on a first rule of the policy, wherein the first rule specifies that the first edge device is to have a key performance indicator (KPI) that exceeds a predetermined threshold.

5. The computer-implemented method of claim 4, wherein the KPI of the first edge device is selected from the group consisting of: available memory resources, computer processing unit resources, access to a predetermined physical component, an amount of processing being performed, and physical movement.

6. The computer-implemented method of claim 1, wherein the AI reasoning model is a neuro-symbolic AI model.

7. The computer-implemented method of claim 1, wherein causing the policy to be altered based on the analysis includes modifying a rule and/or constraints of the policy.

8. The computer-implemented method of claim 1, wherein causing the policy to be altered based on the analysis includes: determining a supplement to the policy, and outputting an indication of the determined supplement.

9. A computer program product, the computer program product comprising a computer readable storage medium having program instructions embodied therewith, the program instructions readable and/or executable by a computer to cause the computer to:
deploy, by the computer, a policy to edge devices in an edge computing environment;
analyze, by the computer, using an artificial intelligence (AI) reasoning model, the policy to understand an intent of deploying the policy, wherein the analyzing includes discounting a weight value assigned to data points that are determined to not apply to a current decision of a first of the edge devices; and
cause, by the computer, the policy to be altered based on the analysis.

10. The computer program product of claim 9, the program instructions readable and/or executable by the computer to cause the computer to: assign, by the computer, weight values to data points associated with the edge devices.

11. The computer program product of claim 10, the program instructions readable and/or executable by the computer to cause the computer to: add, by the computer, to a weight value assigned to data points that are determined to apply to the current decision of the first of the edge devices.

12. The computer program product of claim 9, wherein the analysis is based on a first rule of the policy, wherein the first rule specifies that the first edge device is to have a key performance indicator (KPI) that exceeds a predetermined threshold.

13. The computer program product of claim 12, wherein the KPI of the first edge device is selected from the group consisting of: available memory resources, computer processing unit resources, access to a predetermined physical component, an amount of processing being performed, and physical movement.

14. The computer program product of claim 9, wherein the AI reasoning model is a neuro-symbolic AI model.

15. The computer program product of claim 9, wherein causing the policy to be altered based on the analysis includes modifying a rule and/or constraints of the policy.

16. The computer program product of claim 9, wherein causing the policy to be altered based on the analysis includes: determining a supplement to the policy, and outputting an indication of the determined supplement.

17. A system, comprising:
a processor; and
logic integrated with the processor, executable by the processor, or integrated with and executable by the processor, the logic being configured to:
deploy a policy to edge devices in an edge computing environment;
analyze using an artificial intelligence (AI) reasoning model, the policy to understand an intent of deploying the policy, wherein the analyzing includes discounting a weight value assigned to data points that are determined to not apply to a current decision of a first of the edge devices; and
cause the policy to be altered based on the analysis.

18. The system of claim 17, the logic being configured to: assign weight values to data points associated with the edge devices.

19. The system of claim 17, wherein the analysis is based on a first rule of the policy, wherein the first rule specifies that the first edge device is to have a key performance indicator (KPI) that exceeds a predetermined threshold.

20. The system of claim 17, wherein the AI reasoning model is a neuro-symbolic AI model.
